(19) United States
(12) Patent Application Publication
(10) Pub. No.: US 2005/0146466 A1
(43) Pub. Date: Jul. 7, 2005

(54) Dual-band monopole printed antenna with microstrip chock

(76) Inventors: Shyh-Jong Chung, Hsinchu (TW); Wen-Jiunn Tsay, HsinChu (TW); Kai-Te Chen, Taipei (TW); Yu-Meng Yen, HsinChu (TW)

Correspondence Address: TRANSPACIFIC LAW GROUP, 617 NORTH DELAWARE STREET, SAN MATEO, CA, 94401, US

(21) Appl. No.: 10/746,438

(22) Filed: Dec. 27, 2003

(51) Int. Cl. H01Q 1/24

(52) U.S. Cl. 343/700 MS; 343/702

(57) ABSTRACT

The dual-band monopole printed antenna of this invention comprises: a monopole printed antenna body to perform resonance in response to a first frequency, with one end of the body connected to feed-in line; a tail; and a short-circuited transmission line connecting the other end of the antenna body and an end of the tail; wherein the short-circuited transmission line forms open circuit at its connection with said antenna body when supplied with a current of the first frequency and wherein the antenna body, the transmission line and the tail together perform resonance in response to a second frequency.

### FIELD OF THE INVENTION

The present invention relates to a dual-band monopole printed antenna, especially to a dual-band monopole printed antenna with microstrip chock.

### BACKGROUND OF THE INVENTION

The “dual-band” antenna is a one-piece antenna that can be used to transmit and receive radio wave in two separate frequency bands. Such an antenna combines antennas of two frequency bands into one single element, such that the antenna device may be prepared in a compact size and is useful in all kinds of wireless communications systems, such as handset. Antennas used in the handset may be fabricated with the printing technology in the form of a thin metal wire on printed board. Such antennas are called printed wire antennas and are popularly seen in the fine wireless communication devices.

In the conventional art of the dual-band monopole printed antenna, it is always a task of the engineer to prepare a one-piece printed antenna resonating in response to radio waves of two or more separate frequency bands.

Herve et al. disclosed a “Dual-band transmission device and antenna therefore” in their US patent No. 6,545,640. Provided in that invention is an antenna comprising a body, a tail and a passage connecting the body and the tail. The body, the passage and the tail are printed to a substrate. The body performs quarter-wave type resonance in response to radio wave of a frequency. The body, the passage and the tail together perform quarter-wave type resonance in response to radio wave of another frequency. Both are excited with the same feed-in line. The passage may be an inductive, resistive or controlled component. Such an antenna is compact and suited in the dual-band wireless communication. However, additional cost and difficulties in the design and fabrication of the antenna are caused, due to the use of the conductive, resistive or controlled component.

### OBJECTIVES OF THE INVENTION

It is the objective of this invention to provide a novel dual-band monopole printed antenna to allow resonance of radio waves of two separate frequency bands in a one-piece dual-band antenna, without the need of additional components.

Another objective of this invention is to provide a dual-band monopole printed antenna that is compact and easy to fabricate.

Another objective of this invention is to provide a dual-band monopole printed antenna with microstrip chock.

Another objective of this invention is to provide a method for fabrication of dual-band monopole antenna with microstrip chock.

### SUMMARY OF THE INVENTION

According to this invention, a dual-band monopole printed antenna is provided. The dual-band monopole printed antenna of this invention comprises: a monopole printed antenna body to perform resonance in response to a first frequency, with one end of the body connected to feed-in line; a tail; and a short-circuited transmission line connecting the other end of the antenna body and an end of the tail; wherein the short-circuited transmission line forms open circuit at its connection with said body when supplied with a current of the first frequency and wherein the antenna body, the transmission line and the tail together perform resonance in response to a second frequency.

These and other objectives and advantages of this invention may be clearly understood from the detailed description by referring to the following drawings.

### BRIEF DESCRIPTION OF THE DRAWINGS

FIG. 1 illustrates the structure of the dual-band monopole printed antenna with microstrip chock of this invention.

FIG. 2 illustrates the three-dimensional view of an embodiment of the dual-bald monopole printed antenna of this invention.

FIG. 3 shows the test result of the return loss of the embodiment of FIG. 2.

### DETAILED DESCRIPTION OF THE INVENTION

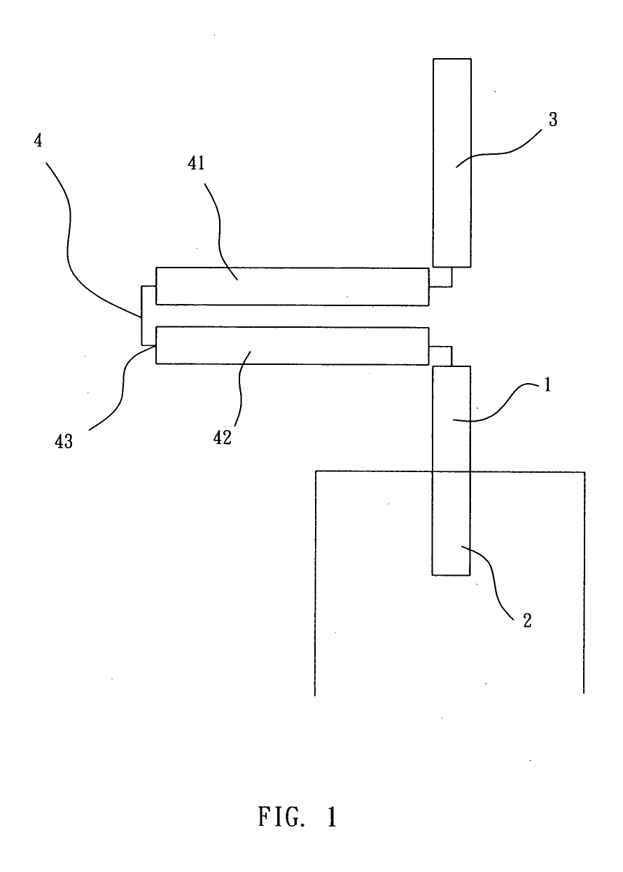

FIG. 1 illustrates the structure of the dual-band monopole printed antenna with microstrip chock of this invention. As shown in this figure, the dual-band monopole printed antenna with microstrip chock of this invention comprises: a monopole printed antenna body 1 to perform resonance when supplied with current of a first frequency, with one end of the body connected to feed in line 2 so to function as a monopole antenna; a tail 3; and a short-circuited transmission line 4 connecting the other end of the antenna body 1 and an end of the tail 3. The short-circuited transmission line 4 comprises two sections of microstrips, the first conductive line 41 and the second conductive line 42, which are parallel and spaced with each other, such that the total length of the short-circuited transmission line 4 equals to a quarter wavelength of signal of a first frequency and that the short-circuited transmission line 4 forms open circuit at its connection with said antenna body 1 when supplied with said signal. The antenna body 1, the short-circuited transmission line 4 and the tail 4 together perform resonance when supplied with current of a second frequency.

In the above elements, the body 1, the short-circuited transmission line 4 and the tail 3 are prepared with, preferably, metal material. In the embodiment of this invention, they are prepared by printing onto printed board (not shown) metal microstrips. In addition, the feed-in line 2 may also be prepared with the printing technology. For example, a metal film printed onto the printed board may function as the feed-in line 2. The body 1, the feed-in line 2, the tail 3 and the short-circuited transmission line 4 may be prepared with the same material or different material. In general, they may be prepared with the same material to simplify the fabrication process.

In the preparation of the antenna body 1, an important requirement is that the antenna body 1 shall be able to perform resonance when a current of the first frequency is supplied to it. Such an effect may be realized by determining the aspect ratio of the antenna body 1. In general, the term “aspect ratio” used here does not involve the width of the microstrip, but only to the length. For example, the length of the antenna body 1 may be determined within a scope wherein the antenna body 1 performs resonance when supplied with current of the first frequency. Here, the first frequency may be the higher band of the two wavebands as applied to the dual-band antenna of this invention and may be, for example, 5 GHz. Suppose the width of the antenna body 1 is 1 mm, its length may be about 5-9 mm. However, the aspect ratio of the antenna body 1 may be determined according to applicable conditions where the antenna is used.

Shape and size of the short-circuited transmission line 4 and the tail 3 are determined according to similar method. In general, major consideration in designing the short-circuited transmission line 4 and the tail 3 includes the total length of the antenna body 1, the short-circuited transmission line 4 and the tail 3. Shape and size of the antenna body 1, the short-circuited transmission line 4 and the tail 3 shall be so designed that they together perform resonance when current of the second frequency is supplied. In the present invention, the second frequency may be the lower band of the two wavebands as applied to the dual-band antenna of this invention and may be, for example, 2.4 GHz. In the determination of the shape and size of the antenna body 1, the short-circuited transmission line 4 and the tail 3, influences to the resonance system caused by the connecting means between the first conductive line 41 and the second conductive line 42 of the short-circuited transmission line 4 and the connection means between the short-circuited transmission line 4 and the antenna body 1 and between the short circuit transmission line 4 and the tail 3, should be taken for consideration and, when necessary, adjustments should be made.

The short-circuited transmission line 4 as used in the invented antenna is one of the features of this invention. Although it is not intended to be limited to any theory, the inventors discovered that open circuit may take place under particular resonance modes to generate a “chock” effect, when using microstrips as component of an antenna. This phenomenon may be explained by the “transmission line theory”.

For a transmission line connected to a load Z_{L}, the input impedance Zᵢₙ at its input end is:

$${Z}_{in} = {Z}_{0} \frac{{Z}_{L} + j {Z}_{0} tan β l}{{Z}_{0} + j {Z}_{L} tan β l} \qquad ( 1 )$$

wherein Z₀ is 50Ω, β=2π/λ, λis the wave length of the electromagnetic wave propagating in the transmission line, j and l are constants.

If the length of the transmission line is λ/4, the input impedance Zᵢₙ shall be:

$${Z}_{in} = \frac{{Z}_{0}^{2}}{{Z}_{L}} \qquad ( 2 )$$

From this relationship, it is found that when load Z_{L}, is “open”, the input impedance is “short”; On the other hand, when load Z_{L} is “shot”, the input impedance is “open”.

According to the above, in the dual-band monopole printed antenna of the present invention, a short-circuited transmission line 4 is used to connect the antenna body 1 and the tail 3. The short-circuited transmission line 4 comprises a first conductive line 41 and a second conductive line 42, both with a length equal to the quarter wavelength of the radio wave of the first frequency. Both conductive lines 41 and 42 are connected by a connection means 43, which forms short when a current is supplied. Length of the antenna body 1 is equal to the quarter wavelength of the radio wave of the first frequency. Tile total length of the antenna body 1, the short-circuited transmission line 4 and the tail 3 is substantially equal to the quarter wavelength of the radio wave of the second frequency. When the antenna body 1 and its following lines and antenna elements are supplied with current of the first frequency, as described above, the input impedance of the short-circuited transmission line 4 is open, such that the current can not enter the tail 3. At this time, the antenna body 1 performs resonance in response to the first frequency current and functions as antenna of the first band.

On the other hand, when the antenna body 1 and its following lines and antenna elements are supplied with current of the second frequency, the transmission line does not perform as a short circuit. At this time, the antenna body 1, the short-circuited transmission line 4 and the tail 3 together perform resonance in response to the second frequency current and function as antenna of the second band.

### EMBODIMENT

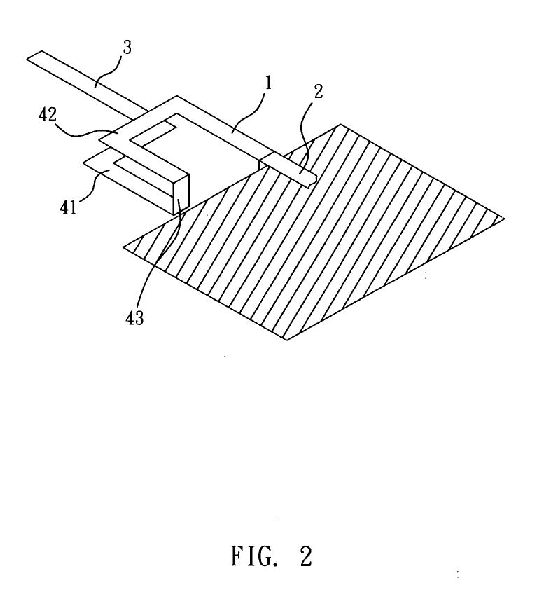

In order to illustrate the effects of the dual-band monopole printed antenna with microstrip chock of this invention, an antenna is prepared according to this invention. FIG. 2 illustrates the three-dimensional view of an embodiment of the dual-band monopole printed antenna of this invention. Components that are the same as those in FIG. 1 are labeled with same numbers.

Before the antenna of this invention is prepared, a printed board is prepared in advance. In order to explicitly show the structure of the invented antenna, the printed board is not shown in FIG. 2. The printed board may be fabricated with any non-conductive material. However, in the general application, a plan epoxy printed board is used. On the first side of the printed board, a metal layer 6 is printed to function as ground. The metal layer 6 may be a copper filament of a substantial surface area. On the first side of the printed board, the tail 3 and the first conductive line 41 of the short-circuited transmission line 4 are printed. In this figure, the tail 3 has a straight section and the first conductive line 41 has bend sections. The shape of these elements, however, is not limited to such. Any other shape of these elements may be used in this invention. In this embodiment, the tail 3 and the first conductive line 41 are prepared by printing onto the printed board microstrips of copper.

On the second side of the printed board, the antenna body 1 is prepared. The antenna body 1 has an extension portion, extended to the area covered by the metal layer 6, at the side opposite to the metal layer 6, to function as feed-in line. On the second side of the printed board, the second conductive line 42 is also prepared. As shown in this figure, the antenna body is a straight section and the second conducive line 42 has bend sections. The shape of these elements, of course, is not limited to such. Any other shape may also be used in these elements. The only requirement of the conductive lines 41 and 42 is that they are parallel and spaced with each other by the printed board. In this embodiment, the antenna body 1 and the second conductive line 42 are prepared by printing onto the printed board microstrips of copper.

When the printed board is prepared, a via hole is provided at the position where the first conductive line 41 and the second conductive line 42 shall connect. Conductive material is applied to the via hole to form connecting means 43 of the first and the second conductive lines 41, 42. In this embodiment, the conducting means 43 is prepared with a Fe—Ni alloy.

The dual-band monopole printed antenna as prepared has the size as shown below:
Length of antenna body: 5 mm
Length of second conductive line: 10 mm
Length of first conductive line: 10 mm
Length of tail: 21 mm.
Width of all microstrips: 1 mm.

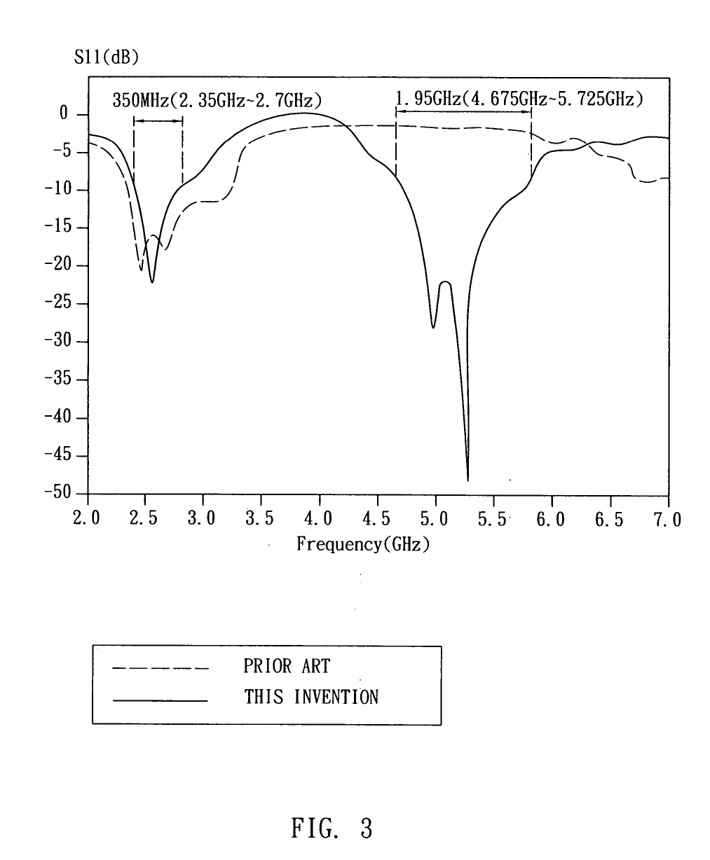

For comparison purpose, another monopole printed antenna is prepared. The monopole antenna is prepared with same material and printed on another printed board. Length of the reference antenna is 23 mm. Supply current of varying frequency to both antennas and measure their return loss with a network analyzer (HP-8722C). The result is shown in FIG. 3. FIG. 3 shows the test result of the return loss of the embodiment of FIG. 2 and of a conventional antenna. As shown in this figure, the dual-band monopole printed antenna of this invention exhibits two resonance bands at around 2.5 GHz and 5.225 GHz.

As the present invention has been shown and described with reference to preferred embodiments thereof, those skilled in the art will recognize that the above and other changes may be made therein without departing form the spirit and scope of the invention.

1. Dual-band monopole printed antenna, comprising:
a monopole printed antenna body to perform resonance in response to a first frequency, with one end of said body connected to a feed-in line;
a tail; and
a short-circuited transmission line connecting the other end of said antenna body and an end of said tail;
wherein said short-circuited transmission line forms open circuit at its connection with said antenna body when supplied with a current of the first frequency and wherein said antenna body, said transmission line and said tail together perform resonance in response to a second frequency.

2. The dual-band monopole printed antenna according to claim 1, wherein said antenna body, said tail and said short-circuited transmission are prepared by printing onto a printed board metal microstrips.

3. The dual-band monopole printed antenna according to claim 1, wherein said short-circuited transmission line comprises two conductive lines in parallel and spaced with each other.

4. The dual-band monopole printed antenna according to claim 3, where length of said two conductive lines equals to a quarter wavelength of radio wave of said first frequency.

5. The dual-band monopole printed antenna according to claim 3, wherein said conductive lines are spaced by a printed board and are connected through a connecting means located in a via hole in said printed board.

6. The dual-band monopole printed antenna according to claim 1, wherein length of said antenna body equals to a quarter wavelength of radio wave of said first frequency and total length of said antenna body, said short-circuited transmission line and said tail equals to a quarter wavelength of radio wave of said second frequency.

7. Method for preparation of a dual-band monopole printed antenna, comprising the steps of:
prepare a printed board with a via hole;
printing onto first side of said printed board a metal layer to function as ground, a first conductive line with one end connected to said via hole and a tail connected to the other end of said conductive line;
printing onto second side of said printed board an antenna body with one end extended to corresponding area of said metal layer and a second conductive line with one end connected to the other end of said antenna body and the other end connected to said via hole; and
prepare a conductive material in said via hole to connect said first and second conductive line;
wherein said first and second conductive lines are parallel and spaced with each other by said printed board.

8. The method according to claim 7 wherein said antenna body, said first and second conductive lines and said tail comprise metal microstrips.

9. The method according to claim 7 wherein length of said two conductive lines equals to a quarter wavelength of radio wave of said first frequency.

10. The method according to claim 7 wherein length of said antenna body equals to a quarter wavelength of radio wave of said first frequency and total length of said antenna body, said first conductive line, said second conductive line and said tail equals to a quarter wavelength of radio wave of said second frequency.
